(19) United States
(12) Patent Application Publication
(10) Pub. No.: US 2026/0349602 A1
(43) Pub. Date: Nov. 5, 2026

(54) DYNAMIC WRITE PARITY LATENCY

(71) Applicant: Micron Technology, Inc., Boise, ID (US)

(72) Inventor: Yong-jae LEE, Suwanee, GA (US)

(21) Appl. No.: 19/560,743

(22) Filed: Mar. 9, 2026

Related U.S. Application Data
(60) Provisional application No. 63/798,339, filed on May 1, 2025.

(51) Int. Cl. G06F 3/06

(52) U.S. Cl. CPC G06F 3/0611; G06F 3/0655; G06F 3/0679

(57) ABSTRACT

In some implementations, a memory system may select a write parity latency for executing a write operation. The memory system may receive a set of data and a first set of parity information associated with the write operation. The memory system may generate a second set of parity information based at least in part on the set of data. The memory system may output, to the host system, an indication of whether an error is detected during an execution of the write operation, wherein whether the error is detected is based at least in part on a comparison of the first set of parity information and the second set of parity information.

### CROSS-REFERENCE TO RELATED APPLICATION

This Patent Application claims priority to U.S. Provisional Patent Application No. 63/798,339, filed on May. 1, 2025, entitled “DYNAMIC WRITE PARITY LATENCY,” and assigned to the assignee hereof. The disclosure of the prior Application is considered part of and is incorporated by reference into this Patent Application.

### TECHNICAL FIELD

The present disclosure generally relates to memory devices, memory device operations, and, for example, to a dynamic write parity latency.

### BACKGROUND

Memory devices are widely used to store information in various electronic devices. A memory device includes memory cells. A memory cell is an electronic circuit capable of being programmed to a data state of two or more data states. For example, a memory cell may be programmed to a data state that represents a single binary value, often denoted by a binary “1” or a binary “0.” As another example, a memory cell may be programmed to a data state that represents a fractional value (e.g., 0.5, 1.5, or the like). To store information, an electronic device may write to, or program, a set of memory cells. To access the stored information, the electronic device may read, or sense, the stored state from the set of memory cells.

Various types of memory devices exist, including random access memory (RAM), read only memory (ROM), dynamic RAM (DRAM), static RAM (SRAM), synchronous dynamic RAM (SDRAM), ferroelectric RAM (FeRAM), magnetic RAM (MRAM), resistive RAM (RRAM), holographic RAM (HRAM), flash memory (e.g., NAND memory and NOR memory), and others. A memory device may be volatile or non-volatile. Non-volatile memory (e.g., flash memory) can store data for extended periods of time even in the absence of an external power source. Volatile memory (e.g., DRAM) may lose stored data over time unless the volatile memory is refreshed by a power source.

### BRIEF DESCRIPTION OF THE DRAWINGS

FIGS. 1 and 2 are diagrams illustrating example systems capable of supporting a dynamic write parity latency.

FIG. 3 illustrates an example of parity circuitry that is capable of supporting a dynamic write parity latency.

FIGS. 4, 5, and 6 are example timing diagrams associated with a dynamic write parity latency.

FIG. 7 is a flowchart of an example method associated with a dynamic write parity latency.

### DETAILED DESCRIPTION

Some memory systems employ techniques to improve the reliability of data stored at the memory system. For example, a memory system may use parity information during write operations to improve the reliability of the data stored during the write operation. In particular, during a write operation, a host system may provide data and first parity information associated with the data to the memory system. The memory system may generate second parity information based on the data, and compare the received first parity information and the generated second parity information. If the memory system determines that the received first parity information and the generated second parity information are the same, the memory system may not detect an error associated with executing the write operation. Additionally, if the memory system determines that the received first parity information and the generated second parity information are different, the memory system may detect an error associated with executing the write operation.

The host system may provide the first parity information associated with the data for a write operation according to a write parity latency. That is, the host system may provide the data to the memory system at a first time and may provide the parity information to the memory system at a second time. The time between the first time and the second time (e.g., the time window corresponding to a time at which the memory system receives a first bit of the data and a time at which the memory system receives a first bit of the parity information) corresponds to the write parity latency. In some cases, the host system may provide the parity information to the memory system according to a fixed write parity latency. Here, the memory system may be configured to perform write operations according the fixed write parity latency. But in some cases, the host system may provide the parity information to the memory system according to a dynamic write parity latency. Here, the memory system may be configured to perform write operations according to a variable dynamic write parity latency.

Some implementations described herein provide a memory system that supports dynamic write parity latency, enabling the memory system to select between two different parity latencies for write operations. For example, the memory system may include a controller coupled to parity circuitry that indicates, to the parity circuitry, whether the parity latency for a write operation is a first amount of time or a second amount of time. The parity circuitry may be configured to generate parity information for data associated with the write operation in accordance with the indicated parity latency. Additionally, the memory system may include a host interface that is configured to transmit signaling, to a host system, indicating whether the memory system detects an error during the write operation based on the received and generated parity information. In some aspects, the parity circuitry may selectively delay the generation of parity information based on the designated parity latency for the write operation. For example, the parity circuitry may introduce a delay into the generation of the parity information if the latency is the first amount of time (e.g., a parity latency of two clock cycles) and refraining from introducing the delay if it is the second amount of time (e.g., a parity latency of three clock cycles). This delay management can be achieved through a multiplexer that selectively outputs a delayed or immediate clock signal based on a control signal.

In this way, the memory system provides technical advantages by accommodating varying operating frequencies and performance demands through support for write operations at different parity latencies. The memory system may conserve processing resources and enhance the efficiency of write operations by maintaining consistent timing parameters for system stabilization across different parity latencies.

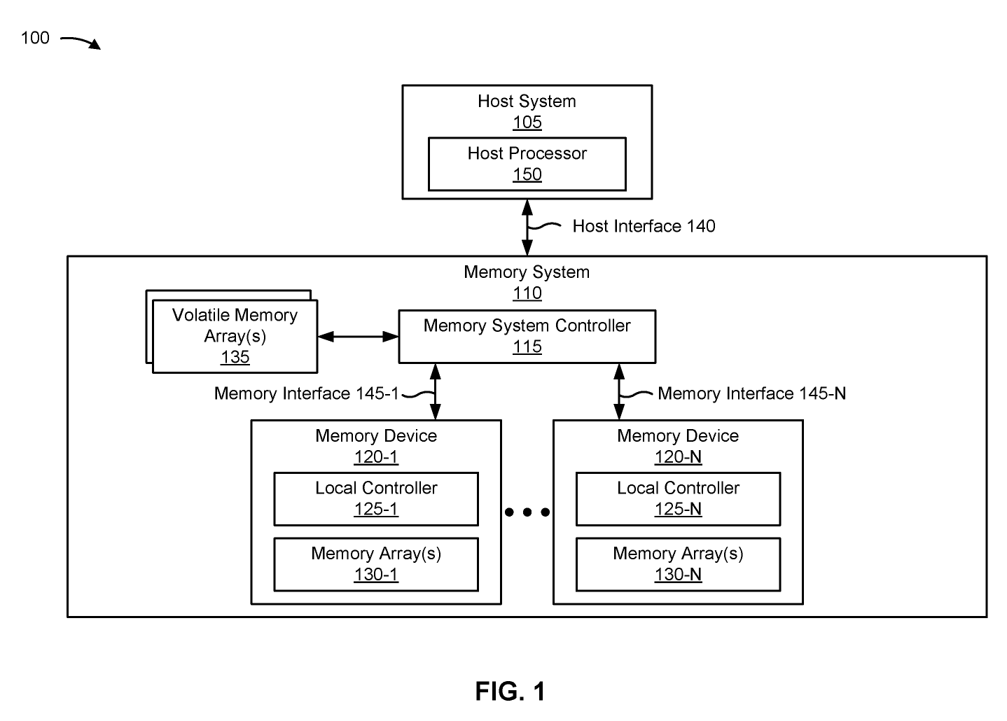

FIG. 1 is a diagram illustrating an example system 100 capable of supporting dynamic write parity latency. The system 100 may include one or more devices, apparatuses, and/or components for performing operations described herein. For example, the system 100 may include a host system 105 and a memory system 110. The memory system 110 may include a memory system controller 115 and one or more memory devices 120, shown as memory devices 120-1 through 120-N (where N ≥ 1). A memory device may include a local controller 125 and one or more memory arrays 130. The host system 105 may communicate with the memory system 110 (e.g., the memory system controller 115 of the memory system 110) via a host interface 140. The memory system controller 115 and the memory devices 120 may communicate via respective memory interfaces 145, shown as memory interfaces 145-1 through 145-N (where N ≥ 1).

The system 100 may be any electronic device configured to store data in memory. For example, the system 100 may be a computer, a mobile phone, a wired or wireless communication device, a network device, a server, a device in a data center, a device in a cloud computing environment, a vehicle (e.g., an automobile or an airplane), and/or an Internet of Things (IoT) device. The host system 105 may include a host processor 150. The host processor 150 may include one or more processors configured to execute instructions and store data in the memory system 110. For example, the host processor 150 may include a central processing unit (CPU), a graphics processing unit (GPU), a field-programmable gate array (FPGA), an application-specific integrated circuit (ASIC), and/or another type of processing component.

The memory system 110 may be any electronic device or apparatus configured to store data in memory. For example, the memory system 110 may be a hard drive, a solid-state drive (SSD), a flash memory system (e.g., a NAND flash memory system or a NOR flash memory system), a universal serial bus (USB) drive, a memory card (e.g., a secure digital (SD) card), a secondary storage device, a non-volatile memory express (NVMe) device, an embedded multimedia card (eMMC) device, a dual in-line memory module (DIMM), and/or a random-access memory (RAM) device, such as a dynamic RAM (DRAM) device or a static RAM (SRAM) device.

The memory system controller 115 may be any device configured to control operations of the memory system 110 and/or operations of the memory devices 120. For example, the memory system controller 115 may include control logic, a memory controller, a system controller, an ASIC, an FPGA, a processor, a microcontroller, and/or one or more processing components. In some implementations, the memory system controller 115 may communicate with the host system 105 and may instruct one or more memory devices 120 regarding memory operations to be performed by those one or more memory devices 120 based on one or more instructions from the host system 105. For example, the memory system controller 115 may provide instructions to a local controller 125 regarding memory operations to be performed by the local controller 125 in connection with a corresponding memory device 120.

A memory device 120 may include a local controller 125 and one or more memory arrays 130. In some implementations, a memory device 120 includes a single memory array 130. In some implementations, each memory device 120 of the memory system 110 may be implemented in a separate semiconductor package or on a separate die that includes a respective local controller 125 and a respective memory array 130 of that memory device 120. The memory system 110 may include multiple memory devices 120.

A local controller 125 may be any device configured to control memory operations of a memory device 120 within which the local controller 125 is included (e.g., and not to control memory operations of other memory devices 120). For example, the local controller 125 may include control logic, a memory controller, a system controller, an ASIC, an FPGA, a processor, a microcontroller, and/or one or more processing components. In some implementations, the local controller 125 may communicate with the memory system controller 115 and may control operations performed on a memory array 130 coupled with the local controller 125 based on one or more instructions from the memory system controller 115. As an example, the memory system controller 115 may be an SSD controller, and the local controller 125 may be a NAND controller.

A memory array 130 may include an array of memory cells configured to store data. For example, a memory array 130 may include a non-volatile memory array (e.g., a NAND memory array or a NOR memory array) or a volatile memory array (e.g., an SRAM array or a DRAM array). In some implementations, the memory system 110 may include one or more volatile memory arrays 135. A volatile memory array 135 may include an SRAM array and/or a DRAM array, among other examples. The one or more volatile memory arrays 135 may be included in the memory system controller 115, in one or more memory devices 120, and/or in both the memory system controller 115 and one or more memory devices 120. In some implementations, the memory system 110 may include both non-volatile memory capable of maintaining stored data after the memory system 110 is powered off and volatile memory (e.g., a volatile memory array 135) that requires power to maintain stored data and that loses stored data after the memory system 110 is powered off. For example, a volatile memory array 135 may cache data read from or to be written to non-volatile memory, and/or may cache instructions to be executed by a controller of the memory system 110.

The host interface 140 enables communication between the host system 105 (e.g., the host processor 150) and the memory system 110 (e.g., the memory system controller 115). The host interface 140 may include, for example, a Small Computer System Interface (SCSI), a Serial-Attached SCSI (SAS), a Serial Advanced Technology Attachment (SATA) interface, a Peripheral Component Interconnect Express (PCIe) interface, an NVMe interface, a USB interface, a Universal Flash Storage (UFS) interface, an eMMC interface, a double data rate (DDR) interface, and/or a DIMM interface.

The memory interface 145 enables communication between the memory system 110 and the memory device 120. The memory interface 145 may include a non-volatile memory interface (e.g., for communicating with non-volatile memory), such as a NAND interface or a NOR interface. Additionally, or alternatively, the memory interface 145 may include a volatile memory interface (e.g., for communicating with volatile memory), such as a DDR interface.

Although the example memory system 110 described above includes a memory system controller 115, in some implementations, the memory system 110 does not include a memory system controller 115. For example, an external controller (e.g., included in the host system 105) and/or one or more local controllers 125 included in one or more corresponding memory devices 120 may perform the operations described herein as being performed by the memory system controller 115. Furthermore, as used herein, a “controller” may refer to the memory system controller 115, a local controller 125, or an external controller. In some implementations, a set of operations described herein as being performed by a controller may be performed by a single controller. For example, the entire set of operations may be performed by a single memory system controller 115, a single local controller 125, or a single external controller. Alternatively, a set of operations described herein as being performed by a controller may be performed by more than one controller. For example, a first subset of the operations may be performed by the memory system controller 115 and a second subset of the operations may be performed by a local controller 125. Furthermore, the term “memory apparatus” may refer to the memory system 110 or a memory device 120, depending on the context.

A controller (e.g., the memory system controller 115, a local controller 125, or an external controller) may control operations performed on memory (e.g., a memory array 130), such as by executing one or more instructions. For example, the memory system 110 and/or a memory device 120 may store one or more instructions in memory as firmware, and the controller may execute those one or more instructions. Additionally, or alternatively, the controller may receive one or more instructions from the host system 105 and/or from the memory system controller 115, and may execute those one or more instructions. In some implementations, a non-transitory computer-readable medium (e.g., volatile memory and/or non-volatile memory) may store a set of instructions (e.g., one or more instructions or code) for execution by the controller. The controller may execute the set of instructions to perform one or more operations or methods described herein. In some implementations, execution of the set of instructions, by the controller, causes the controller, the memory system 110, and/or a memory device 120 to perform one or more operations or methods described herein. In some implementations, hardwired circuitry is used instead of or in combination with the one or more instructions to perform one or more operations or methods described herein. Additionally, or alternatively, the controller may be configured to perform one or more operations or methods described herein. An instruction is sometimes called a “command.”

For example, the controller (e.g., the memory system controller 115, a local controller 125, or an external controller) may transmit signals to and/or receive signals from memory (e.g., one or more memory arrays 130) based on the one or more instructions, such as to transfer data to (e.g., write or program), to transfer data from (e.g., read), to erase, and/or to refresh all or a portion of the memory (e.g., one or more memory cells, pages, sub-blocks, blocks, or planes of the memory). Additionally, or alternatively, the controller may be configured to control access to the memory and/or to provide a translation layer between the host system 105 and the memory (e.g., for mapping logical addresses to physical addresses of a memory array 130). In some implementations, the controller may translate a host interface command (e.g., a command received from the host system 105) into a memory interface command (e.g., a command for performing an operation on a memory array 130).

In some cases, the memory system 110 may be configured to use parity information during write operations to improve the reliability of the data stored during the write operation. Parity information may correspond to one or more bits of information that is associated with a set of data and is a form of error detection code. The parity information may be generated by applying a specific algorithm (such as an exclusive OR (XOR) algorithm) to the data bits. The parity information may then be used to verify the integrity of the data during storage or transmission by comparing the generated parity information with the received parity information to detect any errors.

In particular, during a write operation, the host system 105 may provide data and first parity information associated with the data to the memory system 110. The memory system 110 (e.g., one or more components of the memory system 110 such as the memory controller 115 or a local controller 125) may generate second parity information based on the data, and compare the received first parity information and the generated second parity information. If the memory system 110 determines that the received first parity information and the generated second parity information are the same, the memory system 110 may not detect an error associated with executing the write operation. Additionally, if the memory system 110 determines that the received first parity information and the generated second parity information are different, the memory system 110 may detect an error associated with executing the write operation.

The host system 105 may provide the first parity information associated with data for a write operation according to a parity latency (e.g., a write parity latency for write operations). That is, the host system 105 may provide the data to the memory system 110 at a first time and may provide the parity information to the memory system 110 at a second time. The time between the first time and the second time (e.g., the time window corresponding to a time at which the memory system 110 receives a first bit of the data and a time at which the memory system 110 receives a first bit of the parity information) corresponds to the write parity latency. In some cases, the host system 105 may provide the parity information to the memory system 110 according to a fixed write parity latency. Here, the memory system 110 may be configured to perform write operations according to the fixed write parity latency. But in some cases, the host system 105 may provide the parity information to the memory system 110 according to a dynamic write parity latency. Here, the memory system 110 may be configured to perform write operations according to a variable dynamic write parity latency.

In some implementations, one or more systems, devices, apparatuses, and/or components, of FIG. 1 may be configured to include parity circuitry, coupled to a controller and memory, wherein the parity circuitry is configured to generate, based at least in part on the parity latency, parity information for data associated with the write operation; and a host interface coupled to the controller and the parity circuitry, wherein the host interface is configured to output, to a host system, an indication of whether an error is detected during an execution of the write operation based at least in part on the parity information.

In some implementations, one or more systems, devices, apparatuses, components, and/or controllers of FIG. 1 may be configured to select a write parity latency for executing a write operation; receive a set of data and a first set of parity information associated with the write operation; generate a second set of parity information based at least in part on the set of data; and output, to the host system, an indication of whether an error is detected during an execution of the write operation, wherein whether the error is detected is based at least in part on a comparison of the first set of parity information and the second set of parity information.

The number and arrangement of components shown in FIG. 1 are provided as an example. In practice, there may be additional components, fewer components, different components, or differently arranged components than those shown in FIG. 1. Furthermore, two or more components shown in FIG. 1 may be implemented within a single component, or a single component shown in FIG. 1 may be implemented as multiple, distributed components. Additionally, or alternatively, a set of components (e.g., one or more components) shown in FIG. 1 may perform one or more operations described as being performed by another set of components shown in FIG. 1.

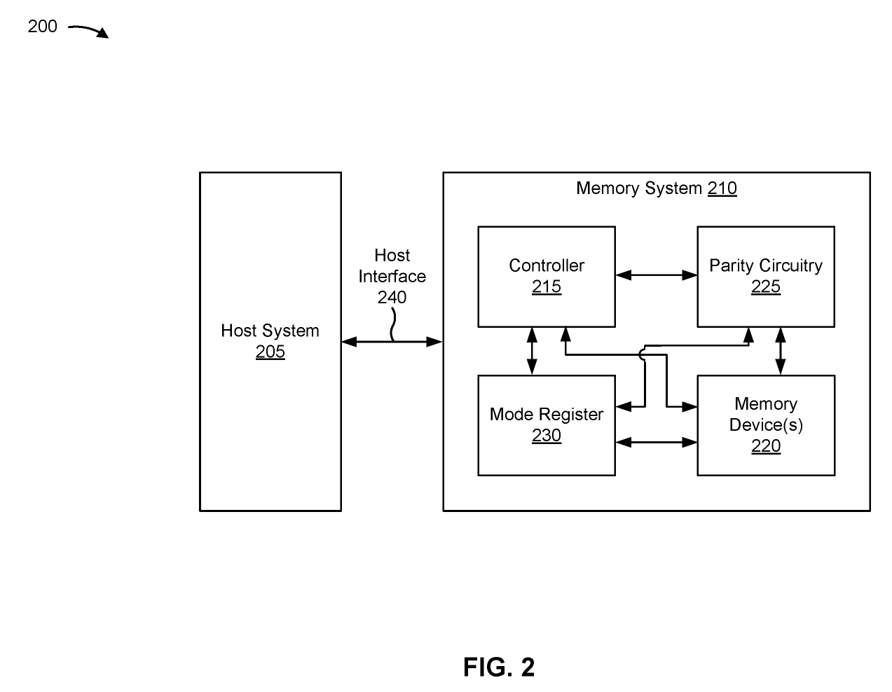

FIG. 2 illustrates an example of a system 200 that supports a dynamic write parity latency. The system 200 may include aspects of the system 100 described with reference to FIG. 1. For example, the host system 205 may be an example of or include aspects of the host system 105, the host interface 240 may be an example of or include aspects of the host interface 140, the controller 215 may be an example of or include aspects of the memory system controller 115, and the memory devices 220 may be examples of or include aspects of the memory devices 120.

The host interface 240 may include a data channel that corresponds to a data bus (e.g., a DQ channel). The host system 205 and the memory system 210 may communicate data via the data bus. For example, during a write operation the host system 205 may communicate data to the memory system 210 via the data channel. In some cases, the data bus may correspond to a 128-bit data bus that operates a DDR.

The host interface 240 may include one or more command and/or address channels (e.g., a CA or RA channel). For example, the host interface 240 may include a column command or address channel, a row command or address channel, or both. The host system 205 may communicate commands (e.g., write commands, read commands) via the command or address channels. For example, the host system 205 may communicate, via a command or address channel, a write command indicating for the memory system 210 to perform a write operation at an address indicated by the write command.

The host interface 240 may include a parity channel (e.g., a PAR channel). The host system 205 and the memory system 210 may communicate parity information via the one or more parity channels. For example, the host system 205 may provide, for a write operation and via the one or more parity channels, parity information associated with a set of data being stored at the memory system 210 during the write operation. In some cases, a width of the parity channel may be based on a width of the data bus. For example, the parity channel may carry one bit of parity information for every 32 bits of data. Accordingly, if the data bus corresponds to a 128-bit data bus, the parity channel may correspond to a 4-bit parity bus.

The host interface 240 may include a parity error channel (e.g., a DERR channel). The host system 205 and the memory system 210 may communicate indications of whether parity errors are detected via the parity error channel. For example, the memory system 210 may communicate, to the host system 205 and via the parity error channel, an indication of whether the memory system 210 detects a parity error while performing a write operation. In some cases, a width of the parity error channel may be based on a width of the data bus. For example, the parity error channel may carry a one-bit parity error indication for every 32 bits of data. Accordingly, if the data bus corresponds to a 128-bit data bus, the parity error channel may correspond to a 4-bit parity error bus.

The memory system 210 may include a mode register 230. The mode register 230 may be configured to store configuration settings for the memory system 210. For example, the host system 205 may program the mode register 230 by sending specific commands or data values to configure various operational parameters of the memory system 210. For example, the host system 205 may transmit a mode register set command to the memory system 210 to program the mode register 230. As an example, the host system 205 may configure timing settings, latency values, and operational modes of the memory system 210 by programming one or more mode registers 230 at the memory system 210.

In the example system 200, the host system 205 may program the mode register 230 to store a value that is indicative of a write parity latency for write operations at the memory system 210. By setting a value stored by the mode register 230, the host system 205 may dynamically configure the write parity latency for write operations (e.g., from a plurality of possible parity latencies for write operations). For example, the host system 205 may indicate whether the write parity latency is a first write parity latency or a second write parity latency by programming the mode register 230 to store a value that is indicative, to the memory system 210, of either the first write parity latency or the second write parity latency. That is, the host system 205 may program the mode register 230 to store a first value to configure the memory system 210 to operate according to the first write parity latency. Additionally, the host system 205 may program the mode register 230 to store a second value to configure the memory system 210 to operate according to the second write parity latency.

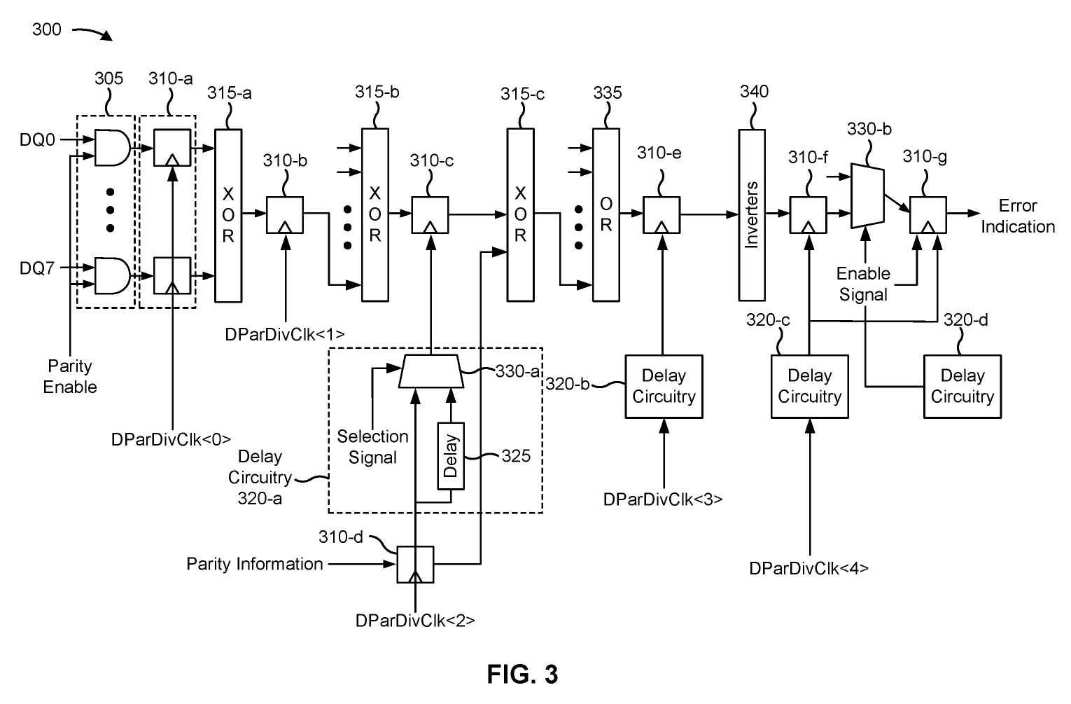

Additionally, the memory system 210 may include parity circuitry 225. The parity circuitry 225 may be configured to generate parity information based on a set of data. For example, during a write operation, the parity circuitry 225 may generate parity information based on the set of data received (e.g., from the host system 205 via the host interface 240). For example, and as described in more detail with reference to FIG. 3, the parity circuitry 225 may include a set of AND logic gates that are configured to receive the set of data and generate parity information associated with the set of data.

The parity circuitry 225 may additionally be configured to compare the generated parity information with received or stored parity information. For example, during a write operation, the parity circuitry 225 may compare the generated parity information with parity information that is received from the host system 205 (e.g., via the host interface 240). If the parity circuitry 225 determines that the received parity information and the generated parity information are the same, the parity circuitry 225 may output an indication, to the host system 205 via the host interface 240, that no parity errors are detected during an execution of the write operation. Additionally, if the parity circuitry 225 determines that the received parity information and the generated parity information are different, the parity circuitry may output an indication, to the host system 205 via the host interface 240, that a parity error is detected during the execution of the write operation.

In some cases, the parity circuitry 225 may generate an indication (e.g., of whether a parity error is detected during the execution of the write operation) that includes more than one bit. That is, the indication may include multiple bits that each indicate whether a parity error is detected within a subset of the data. For example, the indication may include four bits, and each bit may indicate whether the memory system 210 detected a parity error in a corresponding subset of the data (e.g., a fourth of the data, which may correspond to 32 bits). The memory system 210 may output the indication of whether one or more parity errors are detected during the execution of the write operation via a parity error channel (e.g., a PAR channel) of the host interface 240.

The parity circuitry 225 may be configured to generate parity information during write operations according to a dynamic write latency. That is, the controller 215 may determine, based on a value stored by the mode register 230, the write parity latency associated with a write operation. Then, the controller 215 may indicate, to the parity circuitry 225, the write parity latency associated with the write operation. The parity circuitry 225 may dynamically adjust a timing associated with generating and comparing the parity information associated with the data for the write operation in accordance with the write parity latency.

The memory system 210 may output, to the host system 205, the indication of whether any parity errors are detected during the execution of a write operation according to an error indication delay (e.g., a t_{PARDQ}). The error indication delay may correspond to an amount of time between the memory system 210 receiving a first bit of the parity information from the host system 205 and the memory system 210 outputting a first bit of the indication of whether any parity errors are detected during the execution of the write operation. The error indication delay may be independent of the write parity latency. That is, the error indication delay may be the same when the write parity latency is a first value or a second value. For example, the error indication delay may correspond to seven clock cycles if the write parity latency is two clock cycles (e.g., PL2) or three clock cycles (e.g., PL3). By maintaining a consistent error indication delay regardless of the selected write parity latency, the memory system 210 may improve a system stabilization across different parity latencies (e.g., as compared to a memory system 210 that outputs parity error indications according to different error indication delays).

As indicated above, FIG. 2 is provided as an example. Other examples may differ from what is described with regard to FIG. 2.

FIG. 3 illustrates example parity circuitry 300 that is capable of supporting a dynamic write parity latency. The parity circuitry 300 may be an example of the parity circuitry 225. In some cases, the memory system 110 or the memory system 210 may include the parity circuitry 300. The parity circuitry 300 may include AND logic gates 305, flip-flops 310, XOR logic gates 315, delay circuitry 320, a delay component 325, multiplexers 330, one or more OR logic gates 335, and inverters 340.

The parity circuitry 300 may receive a set of data associated with a write operation (e.g., corresponding to DQ0:DQ7). The data may be propagated through the AND logic gates 305 and stored (e.g., latched) by the flip-flops 310-a. The flip-flops 310-a may be configured to receive a clock signal input, and may latch the data based on the clock signal input. In the example parity circuitry 300, the clock signal input to the flip-flops 310-a may correspond to a DParDivClk<0> clock signal.

The AND logic gates 305 may propagate the data based on whether a parity enable signal is high (e.g., whether parity error detection is enabled for write operations). The parity enable signal may be based on whether parity error detection is enabled for write operations. In some cases, the controller (such as the controller 215) may provide the parity enable signal to the parity circuitry 300 based on a value stored in a mode register (such as the mode register 230 or another mode register). That is, a host system may program the mode register to store a value indicative of whether parity error detection is enabled for write operations. If the controller determines that parity error detection is enabled for write operations (e.g., based on the mode register storing a first value indicating that parity error detection is enabled for write operations), the controller may set the parity enable signal to high (e.g., to a logic value ‘1’). Additionally, if the controller determines that parity error detection is disabled for write operations (e.g., based on the mode register storing a second value indicating that parity error detection is disabled for write operations), the controller may set the parity enable signal to low (e.g., to a logic value ‘0’).

The data DQ0:DQ7 may correspond to a subset of the data associated with the write operation. Here, the parity circuitry 300 may include additional components (e.g., associated with other subsets of the data). For example, the parity circuitry 300 may include additional AND logic gates 305 and additional flip-flops 310-a (e.g., that latch the other subsets of the data), additional XOR logic gates 315-a, and additional flip-flops 310-b.

The XOR logic gates 315-a may be configured to receive, as inputs, the data from the flip-flops 310-a. The XOR logic gates 315-a may include a plurality of XOR logic gates 315-a that are configured to compress the data. For example, the XOR logic gates 315-a may be configured to generate a bit of parity information associated with the data.

The flip-flop 310-b may be configured to store (e.g., latch) the output of the XOR logic gates 315-a. In some cases, the flip-flop 310-b may store a bit of parity information associated with a subset of the data associated with a write operation. The flip-flop 310-b may be configured to receive a clock signal input, and may latch the output of the XOR logic gates 315-a based on the clock signal input. In the example parity circuitry 300, the clock signal input to the flip-flop 310-b may correspond to a DParDivClk<1> clock signal.

The XOR logic gates 315-b may be configured to receive a plurality of inputs from a plurality of flip-flops 310-b. In some cases, each of the plurality of flip-flops 310-b may provide, as an input to the XOR logic gates 315-b, parity information for a subset of data associated with a write operation. The XOR logic gates 315-b may include a plurality of XOR logic gates 315-b that are configured to generate parity information for data (or a subset of data) associated with a write operation.

The flip-flop 310-c may be configured to store (e.g., latch) the output of the XOR logic gates 315-b. In some cases, the flip-flop 310-c may store a bit of parity information generated from a set of data (or subset of the data) associated with a write operation. The flip-flop 310-c may be configured to receive a clock signal input, and may latch the output of the XOR logic gates 315-b based on the clock signal input. In the example parity circuitry 300, the clock signal input to the flip-flop 310-b may be based on the DParDivClk<2> clock signal.

The clock signal input to the flip-flop 310-c may be based on a write parity latency associated with the write operation. For example, the parity circuitry 300 may include the delay circuitry 320-a that selectively introduces a delay into a clock signal (e.g., the DParDivClk<2> clock signal) based on the write parity latency associated with the write operation. Accordingly, the clock signal input to the flip-flop 310-c may be either a first clock signal (e.g., the DParDivClk<2> clock signal) or a second clock signal that is delayed as compared to the first clock signal based on the write parity latency associated with the write operation.

The delay circuitry 320-a may include a delay component 325 that is configured to receive, as an input, a first clock signal (e.g., the DParDivClk<2> clock signal). The delay component 325 may then output a second clock signal that is delayed as compared to the first clock signal. For example, the delay component 325 may output a clock signal that corresponds to the DParDivClk<2> clock signal with a delay of a added to the clock signal. The delay circuitry 320-a may additionally include a multiplexer 330-a that is configured to receive, as a first input, the first clock signal (e.g., the DParDivClk<2> clock signal) and, as a second input, the second clock signal that is delayed as compared to the first clock signal (e.g., the DParDivClk<2>+a clock signal).

The multiplexer 330-a may be configured to output a clock signal (e.g., either the first clock signal or the second signal) based on the selection signal. That is, if the selection signal is a first value (e.g., a low voltage), the multiplexer 330-a may output the first clock signal. Additionally, if the selection signal is a second value (e.g., a high voltage), the multiplexer 330-a may output the second clock signal. In some cases, a controller of the memory system (e.g., the controller 215) may apply the selection signal to the multiplexer 330-a based on the write parity latency associated with the write operation. For example, if the write parity latency is a first value, the controller may set the selection signal to a first voltage and if the write parity latency is a second value, the controller may set the selection signal to a second voltage. Accordingly, the multiplexer 330-a may be configured to output a clock signal (e.g., either the first clock signal or the second clock signal) based on the write parity latency associated with the write operation.

The XOR logic gate 315-c may be configured to receive a first input from the flip-flop 310-c and a second input from the flip-flop 310-d. The flip-flop 310-c may be configured to store (e.g., latch) parity information for a set (or subset) of data associated with a write operation that is generated by the parity circuitry 300. The flip-flop 310-d may be configured to store (e.g., latch) parity information for the set (or subset) of data associated with the write operation that is received from a host system. The XOR logic gate 315-c may be configured to compare the generated and received parity information and output an indication of whether the generated and received parity information are the same. That is, if the XOR logic gate 315-c receives the same input from the flip-flop 310-c and the flip-flop 310-d, the XOR logic gate 315-c may output a first signal (e.g., a logic value ‘0’) and if the XOR logic gate 315-c receives different inputs from the flip-flop 310-c and the flip-flop 310-d, the XOR logic gate 315-c may output a second signal (e.g., a logic value ‘1’).

The OR logic gates 335 and the flip-flops 310-e may be configured to generate the parity error indication for the set of data associated with the write operation. That is, the OR logic gates 335 may be configured to receive, from the XOR logic gate 315-c (and one or more other logic gates 315-c associated with other subsets of data) parity information. The OR logic gates 335 may then compress the parity information to generate the parity error indication. The parity error indication may include a plurality of bits of data that indicate, for a plurality of subsets of the data, whether a parity error is detected.

The flip-flops 310-e may be configured to store (e.g., latch) the plurality of bits of the parity error indication. The flip-flops 310-e may be configured to receive a clock signal input, and may latch the output of the OR logic gates 335 based on the clock signal input. In the example parity circuitry 300, the clock signal input to the flip-flop 310-b may be based on the DParDivClk<3> clock signal and the write parity latency associated with the write operation. For example, the parity circuitry 300 may include the delay circuitry 320-b that selectively introduces a delay into a clock signal (e.g., the DParDivClk<3> clock signal) based on the write parity latency associated with the write operation. Accordingly, the clock signal input to the flip-flops 310-e may be either a first clock signal (e.g., the DParDivClk<3> clock signal) or a second clock signal that is delayed as compared to the first clock signal (e.g., the DParDivClk<3 + a clock signal) based on the write parity latency associated with the write operation. The delay circuitry 320-b may include the components described with reference to the delay circuitry 320-a. In the example of the delay circuitry 320-b, the multiplexer may receive the DParDivClk<3> clock signal and the DParDivClk<3 + a clock signal.

The inverters 340, the flip-flops 310-f, the multiplexer 330-b, and the flip-flop 310-g are configured to serialize the parity error indication. Then the parity circuitry 300 may output the serialized parity error indication (e.g., via a parity error channel or a DERR channel) to the host system.

The flip-flops 310-f and the flip-flop 310-g may be configured to store or latch data based on the DParDivClk<4> clock signal and the write parity latency associated with the write operation. For example, the parity circuitry 300 may include the delay circuitry 320-b that selectively introduces a delay into a clock signal (e.g., the DParDivClk<3> clock signal) based on the write parity latency associated with the write operation. Accordingly, the clock signal input to the flip-flops 310-f and the flip-flop 310-g may be either a first clock signal (e.g., the DParDivClk<4> clock signal) or a second clock signal that is delayed as compared to the first clock signal (e.g., the DParDivClk<4 + a clock signal) based on the write parity latency associated with the write operation. The delay circuitry 320-c may include the components described with reference to the delay circuitry 320-a. In the example of the delay circuitry 320-c, the multiplexer may receive the DParDivClk<4> clock signal and the DParDivClk<4 + a clock signal.

The delay circuitry 320 selectively introducing a delay to clock signals based on the write parity latency associated with a write operation may improve a stability of the write parity operations at a memory system while enabling the memory system to output the parity error indication associated with write data according to a delay that is independent of the write parity latency. In particular, if the write parity latency is dynamically configured to be either a first, shorter, write parity latency (e.g., a write parity latency of two clock cycles or PL2) or a second, longer, write parity latency (e.g., a write parity latency of three clock cycles or PL3), the setup and hold margins of some of the flip-flops 310 within the parity circuitry 300 may be different based on the configured write parity latency. Accordingly, the delay circuitry 320 may selectively introduce a delay to the clock signals applied to some of the flip-flops 310 if the configured write parity latency corresponds to the shorter write parity latency (e.g., if the configured write parity latency is two clock cycles or PL2). The selective introduction of the delay may ensure that the setup and hold margins of the flip-flops 310 are met regardless of the configured write parity latency.

As an example, the setup and hold margins of the flip-flop 310-c may be decreased by one clock cycle when the configured write parity latency is the shorter write parity latency (e.g., two clock cycles, PL2). To compensate for the reduced setup margin of the flip-flop 310-c, the delay circuitry 320-a may introduce a delay to the DParDivClk<2> if the configured write parity latency is shorter (e.g., is two clock cycles, PL2). Additionally, the delay circuitry 320-d may be configured to selectively add a delay to the output of the parity error indication based on the configured write parity latency (e.g., if the write parity latency is two clock cycles or PL2). Additionally, to compensate for the margins of sequential flip-flops 310 (e.g., sequential to the flip-flop 310-c), delay circuitry 320 may introduce delays into each clock signal when the configured write parity latency is two clock cycles (e.g., PL2). By selectively adding delays to clock signals, the parity circuitry 300 may maintain consistent margins at various operating frequencies (e.g., various write parity latencies), ensuring that the write parity operations are performed with stability.

As indicated above, FIG. 3 is provided as an example. Other examples may differ from what is described with regard to FIG. 3.

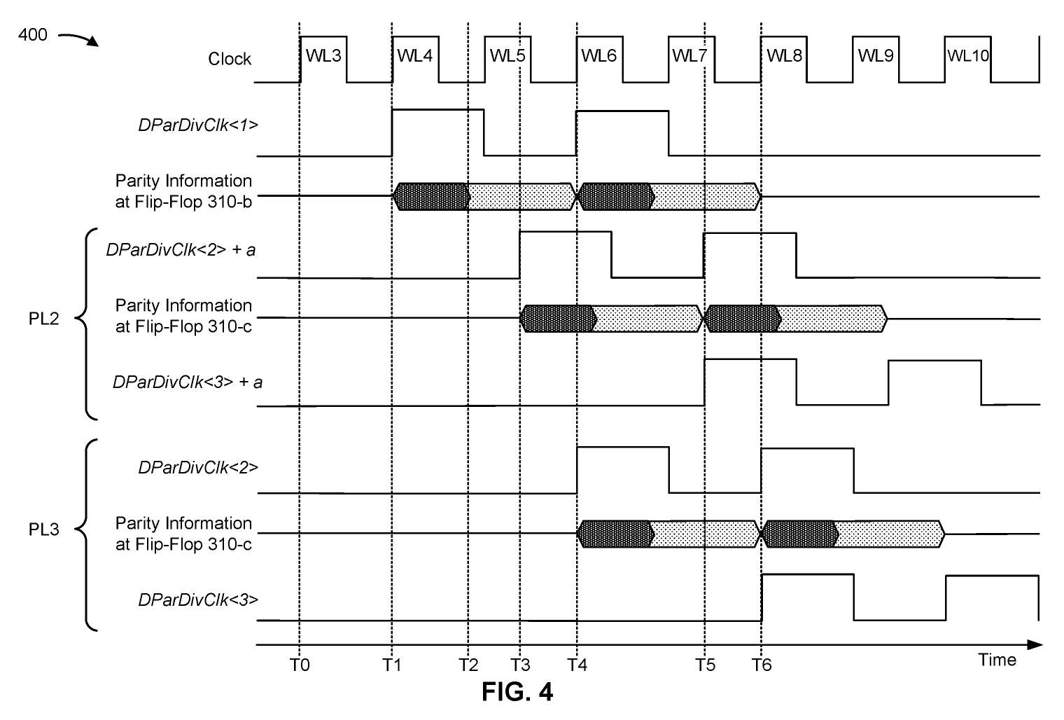

FIG. 4 illustrates an example timing diagram 400 associated with a dynamic write parity latency. In particular, the timing diagram 400 illustrates signals associated with a memory system performing a write operation according to a first write parity latency (e.g., PL2) and a second write parity latency (e.g., PL3). The operations illustrated by the example timing diagram 400 can be performed by the memory system 110 or the memory system 210 and/or one or more components of the memory system 110 or the memory system 210, such as the memory system controller 115, one or more memory devices 120, one or more local controllers 125, the controller 215, and/or the parity circuitry 225.

The timing diagram 400 illustrates the various clock signals that are input to some of the flip-flops described with reference to FIG. 3. For example, the timing diagram 400 illustrates the DParDivClk<1> clock signal, which corresponds to a clock signal applied to the flip-flop 310-b; the DParDivClk<2> clock signal, which corresponds to a clock signal applied to the flip-flop 310-c; and the DParkDivClk<3> clock signal, which corresponds to a clock signal applied to the flip-flop 310-e. The timing diagram 400 additionally illustrates timings associated with operations at the flip-flop 310-b (e.g., as indicated by the parity information at the flip-flop 310-b signal) and at the flip-flop 310-c (e.g., as indicated by parity information at the flip-flop 310-c signal).

The timing diagram 400 indicates differences between the various clock signals (e.g., the DParDivClk<2> clock signal, the DParDivClk<3> clock signal) and the generating of the parity information when a write operation has a write parity latency of two clock cycles (e.g., PL2) and when the write operation has a write parity latency of three clock cycles (e.g., PL3).

Time T0 may correspond to three clock cycles after the memory system receives a first bit of the data associated with a write operation (which may also be annotated as WL3, write latency 3).

At time T1, the DParDivClk<1> clock signal (e.g., that is applied to the flip-flop 310-b) may switch from a low voltage to a high voltage. Accordingly, after time T1, the flip-flop 310-b may latch the parity information that is provided to the flip-flop 310-b (e.g., by the XOR logic gates 315-a). In some cases, the DParDivClk<1> clock signal may switch from the low voltage to the high voltage at a time T1 that corresponds to four clock cycles after the memory system receives the first bit of the data associated with the write operation (e.g., at WL4).

The compressed data information signal may illustrate a hold time associated with latching the compressed data information. That is, the hold time associated with latching the compressed data information may correspond to the time window between time T1 and time T2.

At time T2, the parity information at the flip-flop 310-b may propagate through the XOR logic gates 315-b, to the flip-flop 310-c.

At time T3, if the write parity latency corresponds to two clock cycles (e.g., is PL2), the DParDivClk<2>+a clock signal may switch from a low voltage to a high voltage. Accordingly, after time T3, if the write parity latency is PL2, the flip-flop 310-c may latch the parity information provided to the flip-flop 310-c (e.g., by the XOR logic gates 315-b).

To ensure a stable operation at the memory system, the time between time T3 and time T2 (e.g., when the parity information is propagated from the flip-flop 310-b to the flip-flop 310-c) should be larger than a summation of an amount of time associated with propagating the parity information through the XOR logic gates 310-b and the setup time associated with the flip-flop 310-c. If the parity circuitry 300 does not include the delay circuitry 320-a to add a delay to the DParDivClk<2> clock signal (e.g., a), the amount of time between time T3 and time T2 may not be sufficient.

At time T4, if the write parity latency corresponds to three clock cycles (e.g., is PL2), the DParDivClk<2> clock signal may switch from a low voltage to a high voltage. Accordingly, after time T4, if the write parity latency is PL3, the flip-flop 310-c may latch the parity information provided to the flip-flop 310-c (e.g., by the XOR logic gates 315-b). In some cases, the amount of time between time T2 and time T4 is larger than the summation of the amount of time associated with propagating the parity information from the flip-flop 310-b, through the XOR logic gates 315-b, and to the flip-flop 310-c, and the setup time of the flip-flop 310-c. Accordingly, the parity circuitry 300 may not add the delay to the DParDivClk<2> clock signal when the write parity latency corresponds to PL3.

At time T5, if the write parity latency corresponds to two clock cycles (e.g., is PL2), the DParDivClk<3>+a clock signal may switch from a low voltage to a high voltage.

At time T6, if the write parity latency corresponds to three clock cycles (e.g., is PL3), the DParDivClk<3> clock signal may switch from a low voltage to a high voltage.

As indicated above, FIG. 4 is provided as an example. Other examples may differ from what is described with regard to FIG. 4.

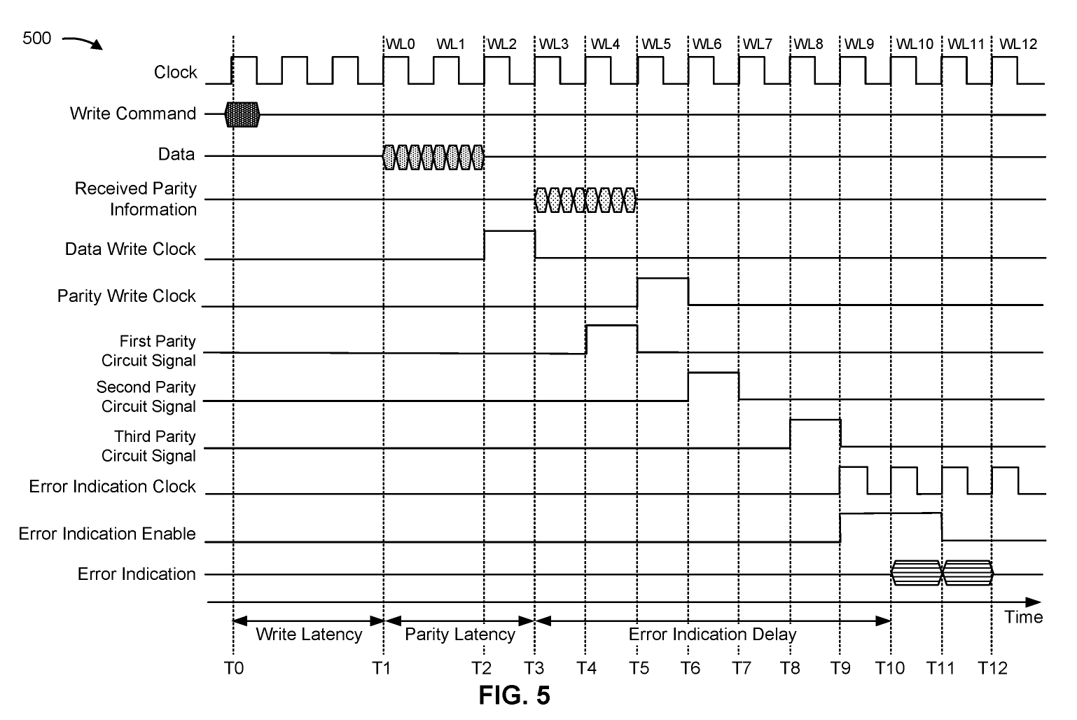

FIG. 5 illustrates an example timing diagram 500 associated with a dynamic write parity latency. In particular, the timing diagram 500 illustrates signals associated with a memory system performing a write operation according to a write parity latency of three clock cycles (e.g., PL3). The operations illustrated by the example timing diagram 500 can be performed by the memory system 110 and/or one or more components of the memory system 110, such as the memory system controller 115, one or more memory devices 120, and/or one or more local controllers 125.

At time T0, the memory system may receive, from the host system, a write command. The write command may indicate for the memory system to execute, at an address, a write operation.

From time T1 to time T2, the memory system may receive, from the host system, data associated with the write operation. The memory system may receive the data associated with the write operation according to a write latency. In the example 500, the write latency may correspond to three clock cycles. Accordingly, the memory system may receive the first bit of the data (e.g., at time T1) three clock cycles after receiving the first bit of the write command.

Time T1 may correspond to a write latency of ‘0’. That is, at time T1 (e.g., once the memory system begins to receive the data associated with the write operation), each subsequent clock cycle may correspond to an increasing write latency (which may be referred to as ‘WL’). That is, the first clock cycle after time T1 may correspond to a WL1, and two clock cycles after time T1 may correspond to a WL2.

At time T2, the data write clock may switch from a low voltage to a high voltage (e.g., from a ground voltage to a reference voltage). In some cases, the data write clock being at a high voltage may correspond to a time that the memory system (e.g., that the parity circuitry at the memory system) latches the data associated with the write operation (e.g., at the flip-flops 310-a). For example, the flip-flops 310-a may latch the data between WL2 and WL3. That is, at time T2, the data write clock switching to the high voltage may correspond to a time that the DParDivClk<0> clock signal switches to the high voltage.

At time T3, the memory system may receive, from the host system, parity information corresponding to the write data. That is, from time T3 to time T5, the memory system may receive the parity information. The amount of time between a beginning of the data transmission (e.g., at time T1, the time that host system provides a first bit of data to the memory system, the time that host system provides the first burst of data to the memory system) and a beginning of the parity information transmission (e.g., at time T3, the time that host system provides a first bit of the parity information to the memory system, the time that the host system provides the first burst of the parity information to the memory system) may correspond to the parity latency. During a write operation, the parity latency may be referred to as a write parity latency. In the example 500, the parity latency may correspond to three clock cycles (e.g., the time between time T1 and time T3 may correspond to three clock cycles). Accordingly, the parity latency for the write operation described with reference to FIG. 5 is PL3.

Additionally, at time T3 the data write clock may switch from the high voltage to the low voltage.

At time T4, the first parity circuit signal may switch from a low voltage to a high voltage (e.g., from a ground voltage to a reference voltage). In some cases, the first parity circuit signal being at a high voltage may correspond to a time that the memory system (e.g., that the parity circuitry at the memory system) latches the parity information at the flip-flop 310-b. For example, the flip-flop 310-b may latch the parity information between WL4 and WL5. That is, at time T4, the first parity circuit signal switching to the high voltage may correspond to a time that the DParDivClk<1> clock signal switches to a high voltage. The first parity circuit signal may also be referred to as an MDwWrClkDerrPh<0> signal.

At time T5, the parity write clock may switch from a low voltage to a high voltage (e.g., from a ground voltage to a reference voltage). In some cases, the parity write clock being at a high voltage may correspond to a time that the memory system (e.g., that the parity circuitry at the memory system) latches the parity information that is associated with the data for the write operation (e.g., at the flip-flop 310-d). For example, the flip-flop 310-d may latch the parity information between WL5 and WL7.

Additionally, at time T5 the first parity circuit signal may switch from the high voltage to the low voltage.

At time T6, the second parity circuit signal may switch from a low voltage to a high voltage (e.g., from a ground voltage to a reference voltage). In some cases, the second parity circuit signal being at a high voltage may correspond to a time that the memory system (e.g., that the parity circuitry at the memory system) latches the parity information at the flip-flop 310-c. For example, the flip-flop 310-c may latch the parity information between WL6 and WL7. That is, at time T6, the second parity circuit signal switching to the high voltage may correspond to a time that the DParDivClk<2> clock signal switches to a high voltage. The second parity circuit signal may also be referred to as an MDwWrClkDerrPh<1> signal.

Additionally, at time T6, the parity write clock may switch from the high voltage to the low voltage.

At time T7, the second parity circuit signal may switch from the high voltage to the low voltage.

At time T8, the third parity circuit signal may switch from a low voltage to a high voltage (e.g., from a ground voltage to a reference voltage). In some cases, the third parity circuit signal being at a high voltage may correspond to a time that the memory system (e.g., that the parity circuitry at the memory system) latches the plurality of bits of the parity error indication at the flip-flop 310-e. For example, the flip-flop 310-e may latch the plurality of bits of the parity error indication between WL8 and WL9. That is, at time T8, the third parity circuit signal switching to the high voltage may correspond to a time that the DParDivClk<3> clock signal switches to a high voltage. The first parity circuit signal may also be referred to as an MDwWrClkDerrPh<2> signal.

At time T9, the error indication clock may begin cycling (e.g., may switch from a low voltage to a high voltage). Additionally, the error indication enable signal may switch from a low voltage (e.g., a ground voltage) to a high voltage (e.g., a reference voltage). In some cases, the error indication enable signal and error indication clock cycling may enable the memory system to output an indication of whether the memory system detected a parity error during an execution of the write operation. Additionally, the third parity circuit signal may switch from the high voltage to the low voltage at time T9.

At time T10, the memory system may begin outputting an error indication to the host system. The error indication may correspond to a parity error indication. That is, at time T10, the memory system may transmit, to the host system, an indication of whether the memory system detected the parity error during the execution of the write operation.

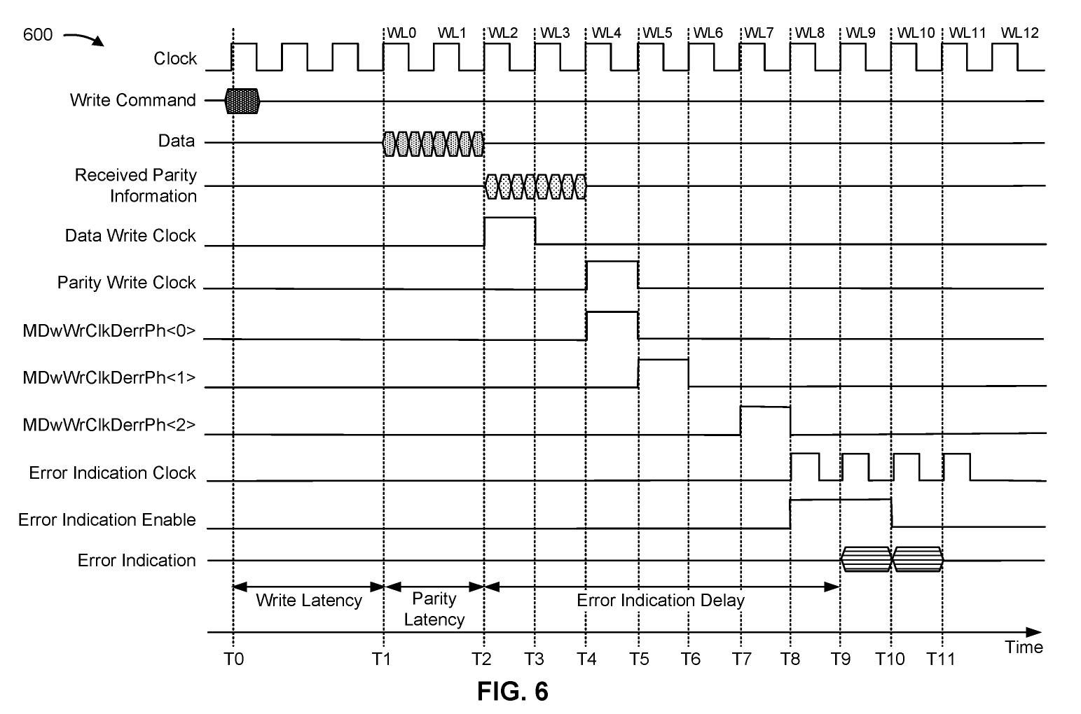

A time between the memory system receiving the parity information (e.g., at time T3) and transmitting the indication of whether the memory system detected the parity error (e.g., at time T10) may correspond to an error indication delay. The error indication delay may also be referred to as t_{PARDQ}. In the example 500, the error indication delay is seven clock cycles. As described herein, the error indication delay may be independent of the configured parity latency for the write operation. For example, and as will be described with reference to FIG. 6, if the error indication delay when the parity latency for a write operation is PL3 is seven clock cycles, the error indication delay when the parity latency for the write operation is PL2 may also be seven clock cycles. The consistency of the error indication delay for different write parity latencies may improve the system stabilization.

At time T11, the error indication enable signal may switch from a high voltage to a low voltage.

At time T12, the memory system may complete the transmission of the error indication to the host system.

As indicated above, FIG. 5 is provided as an example. Other examples may differ from what is described with regard to FIG. 5.

FIG. 6 illustrates an example timing diagram 600 associated with a dynamic write parity latency. In particular, the timing diagram 600 illustrates signals associated with a memory system performing a write operation according to a write parity latency of two clock cycles (e.g., PL2). The operations illustrated by the example timing diagram 600 can be performed by the memory system 110 and/or one or more components of the memory system 110, such as the memory system controller 115, one or more memory devices 120, and/or one or more local controllers 125.

At time T0, the memory system may receive, from the host system, a write command. The write command may indicate for the memory system to execute, at an address, a write operation.

From time T1 to time T2, the memory system may receive, from the host system, data associated with the write operation. The memory system may receive the data associated with the write operation according to a write latency. In the example 600, the write latency may correspond to three clock cycles. Accordingly, the memory system may receive the first bit of the data (e.g., at time T1) three clock cycles after receiving the first bit of the write command.

Time T1 may correspond to a write latency of ‘0’. That is, at time T1 (e.g., once the memory system begins to receive the data associated with the write operation), each subsequent clock cycle may correspond to an increasing write latency (which may be referred to as ‘WL’). That is, the first clock cycle after time T1 may correspond to a WL1, and two clock cycles after time T1 may correspond to a WL2.

At time T2, the data write clock may switch from a low voltage to a high voltage (e.g., from a ground voltage to a reference voltage). In some cases, the data write clock being at a high voltage may correspond to a time that the memory system (e.g., that the parity circuitry at the memory system) latches the data associated with the write operation (e.g., at the flip-flops 310-a). For example, the flip-flops 310-a may latch the data between WL2 and WL3. That is, at time T2, the data write clock switching to the high voltage may correspond to a time that the DParDivClk<0> clock signal switches to the high voltage.

Additionally, the memory system may receive, from the host system, parity information corresponding to the write data at time T2. That is, from time T2 to time T4, the memory system may receive the parity information. The amount of time between a beginning of the data transmission (e.g., at time T1, the time that host system provides a first bit of data to the memory system, the time that host system provides the first burst of data to the memory system) and a beginning of the parity information transmission (e.g., at time T3, the time that host system provides a first bit of the parity information to the memory system, the time that the host system provides the first burst of the parity information to the memory system) may correspond to the parity latency. During a write operation, the parity latency may be referred to as a write parity latency. In the example 600, the parity latency may correspond to two clock cycles (e.g., the time between time T1 and time T2 may correspond to two clock cycles). Accordingly, the parity latency for the write operation described with reference to FIG. 6 is PL2.

At time T3, the data write clock may switch from the high voltage to the low voltage.

At time T4, the parity write clock may switch from a low voltage to a high voltage (e.g., from a ground voltage to a reference voltage). In some cases, the parity write clock being at a high voltage may correspond to a time that the memory system (e.g., that the parity circuitry at the memory system) latches the parity information that is associated with the data for the write operation (e.g., at the flip-flop 310-d). For example, the flip-flop 310-d may latch the parity information between WL4 and WL6.

Additionally, the first parity circuit signal may switch from a low voltage to a high voltage (e.g., from a ground voltage to a reference voltage) at time T4. In some cases, the first parity circuit signal being at a high voltage may correspond to a time that the memory system (e.g., that the parity circuitry at the memory system) latches the parity information at the flip-flop 310-b. For example, the flip-flop 310-b may latch the parity information between WL4 and WL5. That is, at time T4, the first parity circuit signal switching to the high voltage may correspond to a time that the DParDivClk<1> clock signal switches to a high voltage. The first parity circuit signal may also be referred to as an MDwWrClkDerrPh<0> signal.

At time T5, the second parity circuit signal may switch from a low voltage to a high voltage (e.g., from a ground voltage to a reference voltage). In some cases, the second parity circuit signal being at a high voltage may correspond to a time that the memory system (e.g., that the parity circuitry at the memory system) latches the parity information at the flip-flop 310-c. For example, the flip-flop 310-c may latch the parity information between WL5 and WL6. That is, at time T5, the second parity circuit signal switching to the high voltage may correspond to a time that the DParDivClk<2> clock signal switches to a high voltage. The second parity circuit signal may also be referred to as an MDwWrClkDerrPh<1> signal.

At time T5, the parity write clock and the first parity circuit signal may also switch from the high voltage to the low voltage.

At time T6, the second parity circuit signal may switch from the high voltage to the low voltage.

At time T7, the third parity circuit signal may switch from a low voltage to a high voltage (e.g., from a ground voltage to a reference voltage). In some cases, the third parity circuit signal being at a high voltage may correspond to a time that the memory system (e.g., that the parity circuitry at the memory system) latches the plurality of bits of the parity error indication at the flip-flop 310-e. For example, the flip-flop 310-e may latch the plurality of bits of the parity error indication between WL7 and WL8. That is, at time T7, the third parity circuit signal switching to the high voltage may correspond to a time that the DParDivClk<3> clock signal switches to a high voltage. The first parity circuit signal may also be referred to as an MDwWrClkDerrPh<2> signal.

At time T8, the error indication clock may begin cycling (e.g., may switch from a low voltage to a high voltage). Additionally, the error indication enable signal may switch from a low voltage (e.g., a ground voltage) to a high voltage (e.g., a reference voltage). In some cases, the error indication enable signal and error indication clock cycling may enable the memory system to output an indication of whether the memory system detected a parity error during an execution of the write operation. Additionally, the third parity circuit signal may switch from the high voltage to the low voltage at time T8.

At time T9, the memory system may begin outputting an error indication to the host system. The error indication may correspond to a parity error indication. That is, at time T9, the memory system may transmit, to the host system, an indication of whether the memory system detected the parity error during the execution of the write operation.

A time between the memory system receiving the parity information (e.g., at time T2) and transmitting the indication of whether the memory system detected the parity error (e.g., at time T9) may correspond to an error indication delay. The error indication delay may also be referred to as t_{PARDQ}. In the example 600, the error indication delay is seven clock cycles. As described herein, the error indication delay may be independent of the configured parity latency for the write operation. For example, and as described with reference to FIGS. 5 and 6, the error indication delay when the parity latency for a write operation is PL3 and when the parity latency for a write operation is PL2 is seven clock cycles.

At time T10, the error indication enable signal may switch from a high voltage to a low voltage.

At time T11, the memory system may complete the transmission of the error indication to the host system.

As indicated above, FIG. 6 is provided as an example. Other examples may differ from what is described with regard to FIG. 6.

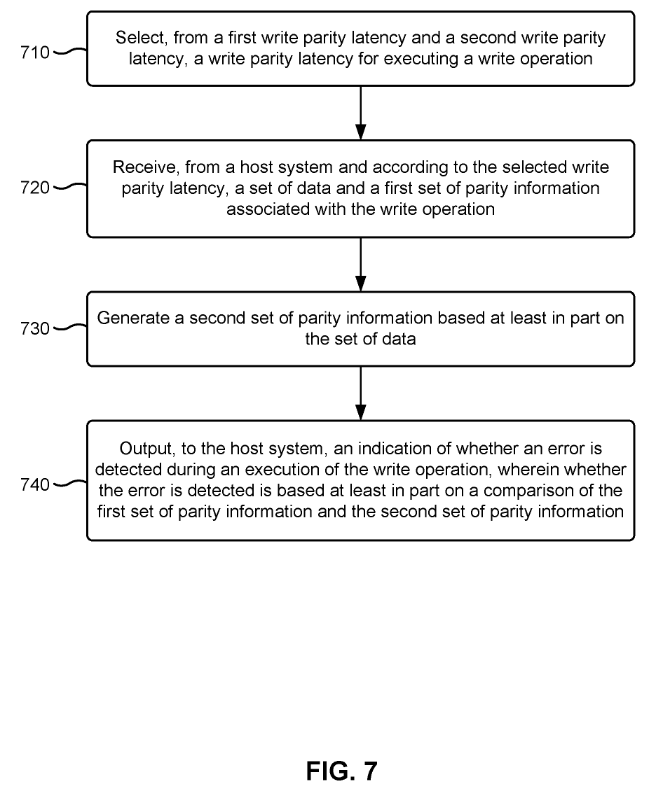

FIG. 7 is a flowchart of an example method 700 associated with a dynamic write parity latency. In some implementations, a memory system (e.g., the memory system 110, the memory system 210) may perform or may be configured to perform the method 700. Additionally, or alternatively, one or more components of the memory system (e.g., the memory system controller 115, a memory device 120, a controller 215, a memory device 220, parity circuitry 225, parity circuitry 300) may perform or may be configured to perform the method 700. Thus, means for performing the method 700 may include the memory system and/or one or more components of the memory system. Additionally, or alternatively, a non-transitory computer-readable medium may store one or more instructions that, when executed by the memory system, cause the memory system to perform the method 700.

As shown in FIG. 7, the method 700 may include selecting a write parity latency for executing a write operation (block 710). As further shown in FIG. 7, the method 700 may include receiving a set of data and a first set of parity information associated with the write operation (block 720). As further shown in FIG. 7, the method 700 may include generating a second set of parity information based at least in part on the set of data (block 730). As further shown in FIG. 7, the method 700 may include outputting, to the host system, an indication of whether an error is detected during an execution of the write operation, wherein whether the error is detected is based at least in part on a comparison of the first set of parity information and the second set of parity information (block 740).

The method 700 may include additional aspects, such as any single aspect or any combination of aspects described below and/or described in connection with one or more other methods or operations described elsewhere herein.

In a first aspect, the selected write parity latency corresponds to an amount of time between receiving the set of data and receiving the first set of parity information.

In a second aspect, alone or in combination with the first aspect, selecting the write parity latency further comprises selecting the write parity latency based at least in part on a value stored by a mode register at the memory system.

In a third aspect, alone or in combination with one or more of the first and second aspects, an amount of time between receiving the first set of parity information and outputting the indication is independent of whether the selected write parity latency corresponds to the first write parity latency or the second write parity latency.

In a fourth aspect, alone or in combination with one or more of the first through third aspects, the first write parity latency corresponds to two clock cycles and the second write parity latency corresponds to three clock cycles.

In a fifth aspect, alone or in combination with one or more of the first through fourth aspects, the method 700 includes comparing the first set of parity information and the second set of parity information, and outputting the indication is based at least in part on the comparing.

In a sixth aspect, alone or in combination with one or more of the first through fifth aspects, the method 700 includes detecting the error during an execution of the write operation based at least in part on determining that the first set of parity information is different from the second set of parity information, and outputting the indication comprises outputting the indication of the error being detected during the execution of the write operation.

In a seventh aspect, alone or in combination with one or more of the first through sixth aspects, the method 700 includes failing to detect the error during an execution of the write operation based at least in part on determining that the first set of parity information is the same as the second set of parity information, and outputting the indication comprises outputting an indication of failing to detect the error during the execution of the write operation.

Although FIG. 7 shows example blocks of a method 700, in some implementations, the method 700 may include additional blocks, fewer blocks, different blocks, or differently arranged blocks than those depicted in FIG. 7. Additionally, or alternatively, two or more of the blocks of the method 700 may be performed in parallel. The method 700 is an example of one method that may be performed by one or more devices described herein. These one or more devices may perform or may be configured to perform one or more other methods based on operations described herein.

In some implementations, a memory system includes a controller configured to indicate, to parity circuitry, whether a parity latency for a write operation is a first amount of time or a second amount of time; the parity circuitry, coupled to the controller, wherein the parity circuitry is configured to generate, based at least in part on the parity latency, parity information for data associated with the write operation; and a host interface coupled to the controller and the parity circuitry, wherein the host interface is configured to output, to a host system, an indication of whether an error is detected during an execution of the write operation based at least in part on the parity information.

In some implementations, a method performed by a memory system includes selecting, from a first write parity latency and a second write parity latency, a write parity latency for executing a write operation; receiving, from a host system and according to the selected write parity latency, a set of data and a first set of parity information associated with the write operation; generating a second set of parity information based at least in part on the set of data; and outputting, to the host system, an indication of whether an error is detected during an execution of the write operation, wherein whether the error is detected is based at least in part on a comparison of the first set of parity information and the second set of parity information.

In some implementations, a memory system includes means for selecting, from a first write parity latency and a second write parity latency, a write parity latency for executing a write operation; means for receiving, from a host system and according to the selected write parity latency, a set of data and a first set of parity information associated with the write operation; means for generating a second set of parity information based at least in part on the set of data; and means for outputting, to the host system, an indication of whether an error is detected during an execution of the write operation, wherein whether the error is detected is based at least in part on a comparison of the first set of parity information and the second set of parity information.

The foregoing disclosure provides illustration and description but is not intended to be exhaustive or to limit the implementations to the precise forms disclosed. Modifications and variations may be made in light of the above disclosure or may be acquired from practice of the implementations described herein.

Even though particular combinations of features are recited in the claims and/or disclosed in the specification, these combinations are not intended to limit the disclosure of implementations described herein. Many of these features may be combined in ways not specifically recited in the claims and/or disclosed in the specification. For example, the disclosure includes each dependent claim in a claim set in combination with every other individual claim in that claim set and every combination of multiple claims in that claim set. As used herein, a phrase referring to “at least one of” a list of items refers to any combination of those items, including single members. As an example, “at least one of: a, b, or c” is intended to cover a, b, c, a + b, a + c, b + c, and a + b + c, as well as any combination with multiples of the same element (e.g., a + a, a + a + a, a + a + b, a + a + c, a + b + b, a + c + c, b + b, b + b + b, b + b + c, c + c, and c + c + c, or any other ordering of a, b, and c).

When “a component” or “one or more components” (or another element, such as “a controller” or “one or more controllers”) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Where only one item is intended, the phrase “only one,” “single,” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. As used herein, the term “multiple” can be replaced with “a plurality of” and vice versa. Also, as used herein, the term “or” is intended to be inclusive when used in a series and may be used interchangeably with “and/or,” unless explicitly stated otherwise (e.g., if used in combination with “either” or “only one of”).

What is claimed is:

1. A memory system, comprising:
a controller configured to indicate, to parity circuitry, whether a parity latency for a write operation is a first amount of time or a second amount of time;
the parity circuitry, coupled to the controller, wherein the parity circuitry is configured to generate, based at least in part on the parity latency, parity information for data associated with the write operation; and
a host interface coupled to the controller and the parity circuitry, wherein the host interface is configured to output, to a host system, an indication of whether an error is detected during an execution of the write operation based at least in part on the parity information.

2. The memory system of claim 1, wherein the parity circuitry selectively delays the generation of the parity information based at least in part on whether the parity latency for the write operation is the first amount of time or the second amount of time.

3. The memory system of claim 2, wherein, to selectively delay the generation of the parity information, the parity circuitry is configured to:
introduce a delay into the generation of the parity information if the parity latency for the write operation is the first amount of time; and
refrain from introducing the delay into the generation of the parity information if the parity latency for the write operation is the second amount of time.

4. The memory system of claim 2, wherein the parity circuitry comprises:
a multiplexer that is configured to selectively delay the generation of the parity information based at least in part on a selection signal applied to the multiplexer.

5. The memory system of claim 4, wherein:
a first input of the multiplexer is coupled to a first clock signal;
a second input of the multiplexer is coupled to a second clock signal that is delayed as compared to the first clock signal; and
the multiplexer is configured to output the first clock signal or the second clock signal based at least in part on the selection signal.

6. The memory system of claim 4, wherein:
the controller is configured to enable the selection signal if the parity latency is the first amount of time; and
the controller is configured to disable the selection signal if the parity latency is the second amount of time.

7. The memory system of claim 1, wherein the parity information corresponds to first parity information, and the host interface is configured to:
receive, from the host system, a first bit of second parity information for the data at a first time; and
output a first bit of the indication to the host system at a second time, wherein an amount of time between the first time and the second time is independent of whether the parity latency for the write operation corresponds to the first amount of time or the second amount of time.

8. The memory system of claim 1, wherein the parity information corresponds to first parity information, and the host interface is configured to:
receive a first bit of the data associated with the write operation at a first time; and
receive a first bit of second parity information for the data at a second time, wherein the parity latency corresponds to an amount of time between the first time and the second time.

9. The memory system of claim 1, further comprising:
a mode register coupled to the controller, wherein the mode register is configured to:
store a first value indicative of the parity latency for the write operation being the first amount of time; or
store a second value indicative of the parity latency for the write operation being the second amount of time.

10. The memory system of claim 9, wherein the controller is configured to:
indicate, to the parity circuitry, that the parity latency for the write operation is the first amount of time based at least in part on the mode register storing the first value; or
indicate, to the parity circuitry, that the parity latency for the write operation is the second amount of time based at least in part on the mode register storing the second value.

11. The memory system of claim 1, wherein:
the parity information corresponds to first parity information;
the host interface is configured to receive, from the host system, second parity information for the data associated with the write operation;
the parity circuitry is configured to compare the first parity information to the second parity information; and
whether the error is detected is based at least in part on the comparing.

12. The memory system of claim 11, wherein the parity circuitry is configured to:
output, to the host interface, a first indication that the error is detected based at least in part on the first parity information and the second parity information being different; or
output, to the host interface, a second indication that the error is not detected based at least in part on the first parity information and the second parity information being the same.

13. A method performed by a memory system, comprising:
selecting, from a first write parity latency and a second write parity latency, a write parity latency for executing a write operation;
receiving, from a host system and according to the selected write parity latency, a set of data and a first set of parity information associated with the write operation;
generating a second set of parity information based at least in part on the set of data; and
outputting, to the host system, an indication of whether an error is detected during an execution of the write operation, wherein whether the error is detected is based at least in part on a comparison of the first set of parity information and the second set of parity information.

14. The method of claim 13, wherein the selected write parity latency corresponds to an amount of time between receiving the set of data and receiving the first set of parity information.

15. The method of claim 13, wherein selecting the write parity latency further comprises:
selecting the write parity latency based at least in part on a value stored by a mode register at the memory system.

16. The method of claim 13, wherein an amount of time between receiving the first set of parity information and outputting the indication is independent of whether the selected write parity latency corresponds to the first write parity latency or the second write parity latency.

17. The method of claim 13, wherein the first write parity latency corresponds to two clock cycles and the second write parity latency corresponds to three clock cycles.

18. The method of claim 13, further comprising:
comparing the first set of parity information and the second set of parity information, wherein outputting the indication is based at least in part on the comparing.

19. The method of claim 18, further comprising:
detecting the error during an execution of the write operation based at least in part on determining that the first set of parity information is different from the second set of parity information, wherein outputting the indication comprises outputting the indication of the error being detected during the execution of the write operation.

20. The method of claim 18, further comprising:
failing to detect the error during an execution of the write operation based at least in part on determining that the first set of parity information is the same as the second set of parity information, wherein outputting the indication comprises outputting an indication of failing to detect the error during the execution of the write operation.

21. A memory system, comprising:
means for selecting, from a first write parity latency and a second write parity latency, a write parity latency for executing a write operation;
means for receiving, from a host system and according to the selected write parity latency, a set of data and a first set of parity information associated with the write operation;
means for generating a second set of parity information based at least in part on the set of data; and
means for outputting, to the host system, an indication of whether an error is detected during an execution of the write operation, wherein whether the error is detected is based at least in part on a comparison of the first set of parity information and the second set of parity information.

22. The memory system of claim 21, wherein the selected write parity latency corresponds to an amount of time between receiving the set of data and receiving the first set of parity information.

23. The memory system of claim 21, wherein the means for selecting the write parity latency further comprise:
means for selecting the write parity latency based at least in part on a value stored by a mode register at the memory system.

24. The memory system of claim 21, wherein an amount of time between receiving the first set of parity information and outputting the indication is independent of whether the selected write parity latency corresponds to the first write parity latency or the second write parity latency.

25. The memory system of claim 21, wherein the first write parity latency corresponds to two clock cycles and the second write parity latency corresponds to three clock cycles.
